(19) United States
(12) Patent Application Publication
(10) Pub. No.: US 2014/0267286 A1
(43) Pub. Date: Sep. 18, 2014

(54) Systems and Methods for Providing an Array Projector

(71) Applicant: Pelican Imaging Corporation, Mountain View, CA (US)

(72) Inventor: Jacques Duparre, Jena (DE)

(73) Assignee: Pelican Imaging Corporation, Mountain View, CA (US)

(21) Appl. No.: 14/199,977

(22) Filed: Mar. 6, 2014

Related U.S. Application Data
(60) Provisional application No. 61/801,733, filed on Mar. 15, 2013.

(51) Int. Cl. G06T 5/00

(52) U.S. Cl. CPC G06T 5/00
USPC 345/428

(57) ABSTRACT

Embodiments of systems and methods for providing an array projector are disclosed. The array projector includes an array of projection components and an image processing system. Each of the projection components projects a lower resolution image onto a common surface area and the overlapping lower resolution image combine to form a higher resolution image. The image processor provides lower resolution image data to each of the projection components in the array. The lower resolution image data is generated using the image processor by applying super resolution algorithms lower resolution image data received by the image processor.

### CROSS-REFERENCE TO RELATED APPLICATIONS

The current application claims priority to U.S. Provisional Patent Application No. 61/801,733, filed Mar. 15, 2013, the disclosure of which is incorporated herein by reference.

### FIELD OF THE INVENTION

This invention relates to the projection of images. More particularly, this invention relates to the projection of low resolution images from an array of projectors to produce a single higher resolution image.

### BACKGROUND

A problem common in the projection of images onto a surface is the provision of high resolution images. The resolution of a projector is often limited by the physical constraints of the projection components (e.g. pixel size of the display) and the lens assembly used to project the image onto a surface. This is particularly true of a projector that is small enough in size to fit into a mobile device such as smart phone, laptop, touch touchpad or other common mobile device. The size needed to place a projector in a mobile device often constrains the resolution that may be achieved.

To overcome this problem, array projectors have been proposed. In an array projector, each individual projector in the array projects a lower resolution image onto the focal plane or projection surface. The images combine to form a higher resolution image on the focal plane. Examples of array projectors are given in “Super-Resolution Composition in Multi-Projector Displays” In. Proc. of IEEE International Workshop on Projector-Camera Systems (ProCams) by Jaynes, C. and Ramakrishnan, D. (2003); “Realizing Super-Resolution with Superimposed Projection” In. Proc. of IEEE International Workshop on Projector-Camera Systems (ProCams) by Damera-Venkata N. and Chang, N. L. (2007); U.S. Pat. No. 6,456,339 titled “Super Resolution Display” issued to Surati et al.; U.S. Pat. No. 7,097,311 titled “Super-resolution Overlay in Multi-projector Displays” issued to Jaynes et al.; and U.S. Pat. No. 7,109,981 titled “Generating and Displaying Spatially Offset Sub-frames” issued to Damera-Venkata et al. However, most of the aforementioned disclosures discuss projection arrays comprising “off-the-shelf” projectors specifically configured in the desired array and calibrated to perform based on the array configuration. These disclosures do not discuss the problems of providing an array projector that may be produced to be installed in a mobile device.

Another example of an array projector is the Fraunhofer IOF system that provides an ultra-thin static array projector. The Fraunhofer system relates to the imaging microoptics on a waferlevel and its integration of an array of static pictures or the microdisplay that provides dynamic partial images. Currently high resolution images may only be projected in the static case. As the picture is static, a lithographically fabricated transparency with an array of images is to be found in the focal plane of the lenses. In spite of the high resolution of this approach, due to the small pixel/feature size in the transparencies, the approach is not very attractive, since the projected image cannot be dynamically changed.

It should be noted that demonstrated dynamic projectors which allow rapid change and hence may use electronic displays, have the disadvantage of comparatively large pixels and consequently can provide an unsatisfactory resolution. Furthermore, the limitation of the pixel size for small projection distances avoids a smooth/complete parallax correction since the required shifts would be smaller than the pixel size.

Thus, it can be seen that the problem in a miniaturized projector can be large display pixel size. In a macroscopic projector that has a lens with a large focal length, a given pixel size is projected onto the projection surface only as a comparatively small pixel. If the focal length is short though, the “lever” in the projection is larger and consequently the pixel is large in the projection surface resulting in the low resolution of the projected image.

### SUMMARY OF THE INVENTION

Systems and methods for providing an array projector are illustrated. In accordance with embodiments of this invention, an array projector includes multiple projection components, and a processing system. Each of the projection components receives lower resolution image data and projects a lower resolution image onto a mutual projection surface based upon the received lower resolution image data and the lower resolution images projected by the plurality of projection components combine to form a higher resolution image. The processing system provides the lower resolution images in the following manner. The processing system receives image data for a higher resolution image to be projected by the projector array from an external source. Inverse super resolution image processing algorithms are applied to the received higher resolution image data to generate lower resolution image data for the lower resolution image to be projected by each of the projection components. The lower resolution image projected by each of the projection components has a lower resolution than the higher resolution image. The processing system provides generated the lower resolution image data to the projection components for display.

In accordance with some embodiments, the projection components include an array of display components and an array of lens stacks. Each one of the lens in the array of lens stacks is aligned with one of display components in the array of display components. In some embodiments, each of the display components comprises an array of light emitting devices. In a number of embodiments, the light emitting devices are one of Light Emitting Diodes (LEDs) and Organic Light Emitting Diodes (OLEDs). In many embodiments, each of the lens stacks has a Modulated Transfer Function (MTF) that is at least equal to the MTF of the high resolution image.

In accordance some embodiments, the array of display components is a monolithic component and the array of lens stacks is a monolithic component that together form a monolithic integrated module. In a number of embodiments, the array of lens stacks are manufactured using a process selected from a group consisting of Wafer Level Optics (WLO), plastic injection molding, and precision glass molding.

In accordance with many embodiments, each of the projection components is configured to project images of a particular color.

In accordance with some embodiments of the invention, the processing system applies photometric correction data to the low resolution image data provided to each of the projection components to correct for photometric errors in each of the projection components. In accordance with many embodiments, the processing system applies geometric correction data to the low resolution image data provided to each of the projection components to correct for geometric errors in each of the projection components. In accordance with many embodiments, the processing systems applies translation data to the low resolution data provided to each of the projection components to configure corresponding pixel projections in the projection components to produce a desired higher resolution image at a given projection distance.

In accordance with some embodiments, the application of the inverse super resolution algorithms includes determining and applying parallax correction for each of the projection components for a given projection distance that includes radical shifts at one of a level selected a sub-pixel level, a pixel level, and a larger than pixel level based upon the projection distance and a position of a channel in a particular projection component in the array. In accordance with many embodiments, the applying of the inverse super resolution processing algorithms includes determining for each of the projection components and applying the inverse super resolution correction data to the lower resolution image data for each of the plurality of projection components to cause an increased resolution in the physical superposition of the lower resolution images projected by each of the plurality of projection components over that resolution of the individually projected images. In accordance with some embodiments, the correction data includes sub-pixel level shifts of the lower resolution data that result from a deviation from a perfect parallax correction.

In accordance with some embodiments of the invention, application of the inverse super resolution processing algorithms includes shifting pixel information in the higher resolution image data by a predetermined amount for each of the plurality of projection components, and downsampling the pixel information in higher resolution image data to a lower resolution pixel grid for the lower resolution image data of each of the projection components where the intensity values of the pixels in lower resolution image data for each of the plurality of projection components are different depending on the amount of the shift of the higher resolution pixel information for the particular projection components and the intensity differences in conjunction with sub-pixel offsets between the projected position of pixels of different projection components later overlap in the projection surface to form the higher resolution image.

In accordance with some embodiments, the processing system applies focal data to the low resolution data to provide a desired resolution at a projection surface for each of the plurality of projection components. In accordance with a number of embodiments, the processing system generates the focal data by performing a focal calibration process.

### BRIEF DESCRIPTION OF THE DRAWINGS

FIG. 1 is a block diagram of an array projector in accordance with an embodiment of the invention.

FIG. 2 conceptually illustrates an optic array and a projection component array in an array projector module in accordance with an embodiment of the invention.

FIG. 3 conceptually illustrates a layout of the location of a reference projection component and associate projection components in an array projector module as well as the location of projection components providing different color images in accordance with an embodiment of the invention.

FIG. 4 illustrates a flow diagram of a process for determining photometric corrections for individual projection components in the array projector in accordance with embodiments of this invention.

FIG. 5 illustrates a flow diagram of a process for determining geometric corrections for individual projector components in the array projector in accordance with embodiments of this invention.

FIG. 6 illustrates a flow diagram of a process for providing a projected image using an array projector in accordance with embodiments of this invention.

FIG. 7 illustrates a flow diagram for providing focal correction data for projection components in an array projector in accordance with embodiments of this invention.

FIG. 8 illustrates a flow diagram for determining pixel depth in a projected image in accordance with embodiments of this invention.

### DETAILED DESCRIPTION

Turning now to the drawings, systems and methods for providing an array projector in accordance with embodiments of the invention are illustrated. In accordance with many embodiments of this invention, an array projector system includes an array projector module and a processing system that performs processes used in projecting images using the array projection module. The array projector module includes an array of projection components. Each projection component includes a digital display device and a lens arrangement. In operation, each of the digital display devices generates a suitably pre-processed downsampled image that is downsampled from an initial high resolution image and the downsampled images is projected by a lens arrangement onto a common area of a surface or object at a certain projection distance such that the combination of the projected downsampled images results in a higher resolution projected image. In accordance with some embodiments, the following processes may be performed to correct for errors that arise from the manufacture or configuration of the display devices and lens arrangements of the projection components in the array module, these processes include parallax correction for a given projection distance (radial shifts at sub-pixel level, pixel level and larger than pixel level, depending on projection distance and position of considered channel in projector array), and inverse super resolution algorithms for improvement of image resolution above that of the downsampled digital images ((statistical) sub-pixel shifts). Super resolution of the overall projected image is achieved by the physical superposition of accordingly sub-pixel shifted projected images.

Array projectors have the same advantage as array cameras in terms of thickness reduction and display brightness (because multiple images overlap in the projection image). However, in the current state of the art the final image is typically just a parallax-corrected superposition of identical images (by different strabismus depending on the projection surface distance), but with the poor resolution of the individual electronic displays in the projector array. In accordance with embodiments of this invention, inverse super resolution algorithms (projection of sub-pixel shifted projected images) similar to the super resolution algorithms used in an array camera are also used to increase the resolution of the projected image of the projector array.

An array projector is similar to an array camera, such as the array camera described in U.S. patent application Ser. No. 12/935,504 entitled “Capturing and Processing of Images using Monolithic Camera Array with Heterogeneous Imagers” to Venkataraman et al., and can be utilized to project a High Resolution (HR) image by projecting multiple low resolution images onto the same focal plane. In a number of embodiments, super resolution images are formed in a manner similar to those described in U.S. patent application Ser. No. 12/967,807 entitled “Systems and Methods for Synthesizing High Resolution Images Using Super-Resolution Processes” to Lelescu et al., where a higher resolution 2D image or a stereo pair of higher resolution 2D images is generated from lower resolution images projected by individual projection components of an array projector. The terms high or higher resolution and low or lower resolution are used here in a relative sense and not to indicate the specific resolutions of the images projected by the array projector. The disclosures of U.S. patent application Ser. No. 12/935,504 and U.S. patent application Ser. No. 12/967,807 are hereby incorporated by reference in their entirety.

Each projected two-dimensional (2D) image projected onto a display in a sub-pixel-shifted location is from the viewpoint of one of the projection components in the array projector. A high resolution image that results from the superposition of the projected images is from a specific viewpoint that can be referred to as a reference viewpoint. The reference viewpoint can be from the viewpoint of one of the projection components in the array projector. Alternatively, the reference viewpoint can be an arbitrary virtual viewpoint.

Due to the different viewpoint of each of the projection components, parallax results in variations in the position of foreground objects within the individual projected images of the scene. To provide the super resolution image, in accordance with some embodiments of this invention, the processes include, but are not limited to, processes for calibrating for photometric errors in the projection components of the array projector, processes for calibrating for geometric errors in the projection components in the projector array, processes for calibrating for focal or depth errors in the projected image, processes for correcting the images based upon the data generated by the calibration processes and processes for applying inverse super resolution algorithms to the higher resolution image data to generate the lower resolution images data of the lower resolution images projected by each of the projection components in the array.

### Array Projectors

An array projector in accordance with embodiments of the invention can include a projector module, a range finder/camera system, and a processing system. An array projector in accordance with an embodiment of the invention is illustrated in FIG. 1. The array projector 100 includes a projector module 102 with an array of individual projection components 104 where an array of individual projection components refers to a plurality of projection components in a particular arrangement, such as (but not limited to) the square arrangement utilized in the illustrated embodiment. The projector module 102 is connected to a processor 106. The processor 106 is connected to a memory 108 and range finder/camera 110. In the shown embodiment, range finder/camera 110 is an array camera. Array cameras can be utilized to capture image data from different viewpoints (i.e. light field images) are disclosed in U.S. patent application Ser. No. 12/935,504 entitled “Capturing and Processing of Images using Monolithic Camera Array with Heterogeneous Imagers” to Venkataraman et al. As is discussed further below array cameras and/or multi-view stereo cameras can capture depth information within a scene and knowledge of the differing disparity required to super-resolve images at different depths can be used to manipulate low resolution images to project onto uneven surfaces.

Although a specific embodiment of an array projector with a specific configuration is described above with reference to FIG. 1, one skilled in the art will recognize that other configurations of an array projector are possible without departing from embodiments of this invention.

### Array Projector Modules

Projector modules in accordance with embodiments of the invention can be constructed from a display array and an optic array. The optics project the images of the display onto the projection surface (channel-wise). A projector module in accordance with an embodiment of the invention is illustrated in FIG. 2. The projector module 200 includes an array display 230 including display components 240 along with a corresponding optic array 210 including an array of lens stacks 220. Each display component 240 either includes an array of light emitting devices such as LEDs or organic LEDs (OLEDs, also OLED on CMOS would be possible). In some embodiments, the display component may be a transmissive display such as, but not limited to, a Liquid Crystal Display (LCD) combined with a homogenized light source (e.g. LED) on a backside of the LCD. Each display generates an image in accordance with projection image data received from the processor 106.

In several embodiments, color filters in individual imaging components can be used to pattern the projected image with it filter groups similar to the fashion it filter groups further discussed in relation to an array camera in U.S. Provisional Patent Application No. 61/641,165 entitled “Camera Modules Patterned with Pi Filter Groups” filed May 1, 2012, the disclosure of which is incorporated by reference herein in its entirety. The use of a color filter pattern incorporating it filter groups in a 4×4 array is illustrated in FIG. 3. These projection components can be used to project data with respect to different colors, or a specific portion of the spectrum. In contrast to applying color filters to the pixels of the individual projection components, color filters in many embodiments of the invention are included in the lens stack. For example, a green color projection component can include a lens stack with a green light filter that allows green light to pass through the optical channel. In many embodiments, the pixels in each focal plane are the same and the light information projected by the pixels is differentiated by the color filters in the corresponding lens stack for each filter plane. Although a specific construction of a projector module with an optic array including color filters in the lens stacks is described above, projector modules including it filter groups can be implemented in a variety of ways including (but not limited to) by applying color filters to the pixels of the projection components of the projection module similar to the manner in which color filters are applied to the pixels of a conventional color projector. In several embodiments, at least one of the projection components in the projection module can include uniform color filters applied to the pixels in its focal plane. In many embodiments, a Bayer filter pattern is applied to the pixels of at least one of the projection components in a projector module. In a number of embodiments, projector modules are constructed in which color filters are utilized in both the lens stacks and on the pixels of the projection array.

In several embodiments, an array projector projects image data for multiple focal planes and uses a processor to synthesize one or more LR images of a scene. In certain embodiments, the image data projected by a single projector component in the projector array can constitute a low resolution image (the term low resolution here is used only to contrast with higher resolution images), which combines with other low resolution image data projected by the projector module to construct a higher resolution image through Super Resolution (SR) processing.

Within the array of lens stacks, each lens stack 220 creates an optical channel that focuses an image of the scene projected by a projection component on a focal plane or projection surface distal from the array projector. Each pairing of a lens stack 220 and display component 240 forms a single projector 104 within the projector module 200.

Each lens stack 220 is specified in terms of the Modulation Transfer Function (MTF) curve over a range of spatial frequencies. The MTF is a Spatial Frequency Response (SFR) of the output signal contrast with the input spatial frequency. At low frequencies, the display components 240 typically pass the signal unattenuated, which implies a contrast of 100%. At higher frequencies, the signal is attenuated and the degree of attenuation in the output signal from the display component 240 is expressed as a percentage with respect to the input signal. In an array projector, it is desirable to receive content above the Nyquist frequency to allow the super-resolution process to produce higher resolution information. When multiple copies of an aliased signal are present, such as in multiple images from the projection components 240, the information inherently present in the aliasing may result in a higher resolution image. One skilled in the art will note that the aliasing patterns from the different display components 240 have slight differences due to the diversity of the projected images. These slight differences result from the slightly different projection directions of the projection components and result in aliasing in the low resolution images that is either intentionally introduced or results from positional manufacturing tolerances of the individual focal planes. Thus, in accordance with some embodiments of this invention, the MTFs of the lens stacks 220 need to be at least as high as the desired high resolution output MTF to provide sufficient contrast.

An optic array of lens stacks may employ wafer level optics (WLO) technology. WLO is a technology that encompasses a number of processes, including, for example, molding of lens arrays on glass wafers, stacking of those wafers (including wafers having lenses replicated on either side of the substrate) with appropriate spacers, the optics array can then be packaged with the display array into a monolithic integrated module. In accordance with many embodiments, each of the lens stacks 200 is paired with a display component 240 that is separate from other display components 240 and separately mounted on a substrate.

The WLO procedure may involve, among other procedures, using a diamond-turned mold to create each plastic lens element on a glass substrate. More specifically, the process chain in WLO generally includes producing a diamond turned lens master (both on an individual and array level), then producing a negative mould for replication of that master (also called a stamp or tool), and then finally forming a polymer replica on a glass substrate, which has been structured with appropriate supporting optical elements, such as, for example, apertures (transparent openings in light blocking material layers), and filters. Although the construction of optic arrays of lens stacks using specific WLO processes is discussed above, any of a variety of techniques can be used to construct optic arrays of lens stacks, for instance those involving precision glass molding, polymer injection molding or wafer level polymer monolithic lens processes. Any of a variety of well known techniques for designing lens stacks used in conventional cameras and/or projectors can be utilized to increase aliasing in captured images by improving optical resolution.

In accordance with a number of embodiments, each lens stack in the array may be individually manufactured and mounted onto a carrier. The carrier includes holes that correspond to each underlying displays. Each individual lens stack is mounted on a hole over a corresponding the display. The hole may include filters such as, but not limited to color and IR cut-off filters mounted inside the holes to limit the frequencies of light emitted through the lens stacks. An active alignment process is performed to align each of the lens stacks to the carrier. The process is similar to the process described for manufacturing an array camera defined in U.S. Provisional Patent Application 61/901,378 entitled in Non-Monolithic Array Module with Discrete Sensors and Discrete Lens, in the name Rodda et al., filed 7 Nov. 2013.

The configuration of different projection components to project low resolution images that combine to form a higher resolution image in accordance with embodiments of this invention are shown in FIG. 3. As shown in FIG. 3, the array projector includes a reference projection component 304 and one or more associate projection components 306 that are associated with the reference projection component 304. In accordance with the shown embodiment, each of the projection components may be configured to transmit images of a particular color (Blue, Green, or, Red) to improve the color quality of the combined projected image. In other embodiments, each imaging component may project multi-color images that are combined to form the higher resolution image. The exact combination is left as a design choice depending on the desired qualities of the combined image.

### Process for Calibrating to Correct Photometric Errors

To achieve high quality images, the projection components project images of substantially the same quality. Ideally, each projection component provides projected images having substantially the same Modulation Transfer Function (MTF). However, defects caused by the manufacture or the material of the light emitting devices may cause the MTF and other photometric properties of the individual projection components of individual projection components to vary. Accordingly, the projection imaging data provided to the projection components may be modified to compensate for the photometric errors introduced by these defects. A calibration process for detecting photometric errors and generating correction data to correct for photometric errors and/or variation in the projection components in accordance with embodiments of this invention is illustrated in FIG. 4.

Process 400 includes projecting a test pattern with each projection component (405), capturing an image of the projected image with an image capture device (410), analyzing the captured images to determine photometric correction values (415), applying the photometric correction data to the test pattern images (420), determining whether the corrected images are acceptable (425), and repeating the process until the corrected images are acceptable (430). Each projection component projects a test pattern image, one at time, in order to allow the particular photometric properties of individual projection components (405) to be displayed. The test pattern should have a specific contrast and brightness that is easily discernible to allow photometric errors to be detected and measured. The image projected by each projection component is then captured by the camera (410). In accordance with some embodiments, the camera is associated with processing system of the array projector and the distance of the camera from the focal plane or projection surface of the projected image is either known or easily calculated.

The captured image of each projection component is then analyzed to detect the photometric errors in the captured image (425). This may be performed in the same manner as is performed for a conventional projector. Photometric correction data is then calculated for the detected errors in each projection component. One skilled in the art will recognize that this may be done on a per pixel basis or regionally by grouping the pixels into discrete sets. The photometric correction data may include gain and offset coefficients; MTF adjustments; and data for correcting other photometric errors. The photometric correction data for each projection component is then stored for using in image generation.

The calculated photometric correction data is then applied to the test pattern data of each projection component. Each projection component then projects an image using the corrected data (425). The projected images are then captured and tested to determine if the corrected images are acceptable within a predetermined tolerance. If the images are not acceptable, the process is repeated using the photometric correction data to provide the test pattern image data to the projection components. Otherwise, the correction data is acceptable and process 400 ends.

Although a specific process for detecting photometric errors and generating correction data to correct the photometric errors in the projection components in accordance with embodiments of this invention with respect to FIG. 4, any of a variety of processes may be utilized in accordance with embodiments of the invention.

### Geometric Calibration of Projection Components

To provide a high resolution image, the individual projection components must project corresponding pixels on the same area of the focal plane or projection surface. Typically, the projection components are aligned such that corresponding pixel information from the different projection components is projected onto the same area of the focal plane or projection surface. However, errors in the light emitting device or lens stack of the individual projection components may cause misalignments of the projected pixels. A process for calibrating to correct for geometric errors in the individual projection components in accordance with embodiments of this invention is illustrated in FIG. 5.

Geometric calibration process 500 includes projecting a test pattern with each of the projection components (505), capturing an image of the projected image (510), comparing the captured images from associate projection devices to the captured images of the reference projection components (515), determining translation data for translating each pixel projected by an associate projection component to a corresponding pixel projected by the reference projection component (520), and storing the translation data for each associate projection component for use generating in projected image data (525). The images of test patterns are individually projected by each of the projection components (505). The test pattern image includes a pattern that has easily identifiable reference points in various regions of the projected image. Ideally, the identified points are sufficiently placed in the image to allow detection of the alignment between images from the different projection components. The camera or image capture system used to capture the images (510) should be a known distance from the focal plane or projection surface or the distance should be able to be easily ascertained to aid in the determination of the translation information of each projection component.

The positions of the reference points are then identified in captured images for each of the projection components and compared (515). The positions of the reference points in the captured images of the reference projection components and the positions of the reference points in the associate projection components associated with each reference projection component are compared (520). Translation data for translating the position of the projected pixels of each of the associate projection components to the position of the projected pixels of the reference projection components is then determined from comparisons. In accordance with some embodiments, the translation data may be determined on a pixel by pixel basis for each of the associated projection components. In accordance with a number of embodiments, the translation data for each associate projection component is determined for a group of pixels in a region of the image where the pixels of the projection component are grouped in related sets. The translation data for each reference projection component is then saved for use in generating the projection data of the reference projection components (525).

Although a specific process for calibrating to correct for geometric errors in the individual projection components in accordance with embodiments of this invention with respect to FIG. 5, any of a variety of processes may be utilized in accordance with embodiments of the invention.

### Process for Generating Projection Data

At the time an image is to be projected, the information generated during the various calibration processes is used to modify the data of the projection data to correct for the detected errors associated with aspects of the array projector including (but not limited to) imperfections in the optics and/or display components of the individual projection components. A process for generating the projection data provided to the individual projection components in accordance with embodiments of this invention is illustrated in FIG. 6. One skilled in the art will recognize that the displays or projection components are physically fixed as is their individual correspondence to the corresponding lens stack. Lower resolution images projected by each of the projection components combine to form a higher resolution image on a mutual projection surface. The lower resolution images are projected from each of the projection components using lower resolution data. The lower resolution data is generated from input image data that is image data for a higher resolution image. In accordance with embodiments of this invention, the input image data needs to have a much higher resolution than the downsampled component images (at least as high as the resolution of the desired HR projected image). By laterally shifting those images by HR-pixels and then only downsampling to the LR pixel grid, the intensity values of the LR pixels are different depending on which amount of HR-pixel (=sub-LR-pixel) shift the original image has seen. These intensity differences in conjunction with sub-pixel offsets between the projected position of LR pixels of different projection components later overlapping in the projection surface make the resolution increase possible.

Process 600 includes the following sub-processes. Photometric correction data that corrects for detected photometric errors in the individual projection components is applied to the projection image data of each of the individual projection components (605). Translation data to correct for geometric errors detected in the individual projection components is applied to the projection image data of each of the associate projection components to align the projected pixels of the associate projection components with corresponding projected pixels of the reference projection components (610).

Focal data is then applied to the projection image data of each of the projection components (615). In accordance with some embodiments, the focal data may change the focal points to varying depths and the user selects the depth that provides a desired resolution on the focal plane or projection surface. In accordance with other embodiments, an auto-focus process may be performed based upon data collected by a range finder or camera. An example of an auto-focus process in accordance with this invention is described below with reference to FIGS. 7 and 8. After all of the corrections have been made to the image projection data, the image projection data is transmitted to the proper projection components and is projected onto the focal plane or projection surface.

Although a specific process for generating the projection data providing the projection components in accordance with embodiments of this invention with respect to FIG. 6, any of a variety of processes may be utilized in accordance with embodiments of the invention.

### Auto-focus Process

It can be appreciated that resolution may be effected by errors in the focal distance of the projections. Focal distance errors may arise from any number of causes. Examples of causes of focal distance errors include, but are not limited to, defects in the lens array and an uneven projection surface. A process for detecting focal distance errors and generating focal data in accordance with embodiments of this invention is illustrated in FIG. 7.

Process 700 includes projecting an image from the array projector onto a particular focal plane or projection surface (705). The pixel depth of projected pixels in different areas of the focal plane or projection surface is determined (710). In accordance with some embodiments, the pixel depth may be determined by a range finder, such as, but not limited to, a laser system. In accordance with some other embodiments, the pixel depth is determined using an array camera or other type of stereoscopic camera system. A process for determine pixel depth in accordance with some embodiments of this invention is described below with reference to FIG. 8.

Based on the pixel depth information determined for the image, focal data that corrects for the determined pixel depth for each projected pixel in the projected image is determined (715). The focal data for the pixel positions in the image are then translated for the corresponding projected pixel positions in each of the individual projection components (720). The focal data for each of the projection components is then stored for projection image generation (725).

Although a specific process for detecting focal distance errors and generating focal data in accordance with embodiments of this invention with respect to FIG. 7, any of a variety of processes may be utilized in accordance with embodiments of the invention.

A process for determining the depth of projected pixels on the focal plane or projected surface in accordance with embodiments of this invention is illustrated in FIG. 8. This process is especially useful when the focal plane is on an uneven projection surface as the varying distances to the surface cause focal errors different regions of the projected image. Process 800 includes capturing an image of an image projected by the array projector (805) with an array camera such as the array camera 110 associated with the array projector 100 and determining a depth map of the projected pixels in the projected image. Due to the different viewpoint of each of the imaging components, parallax results in variations in the position of foreground objects within images of the scene captured by the array camera. As is disclosed in U.S. Provisional Patent Application Ser. No. 61/691,666 entitled “Systems and Methods for Parallax Detection and Correction in Images Captured Using Array Cameras” to Venkataraman et al., a depth map from a reference viewpoint can be generated by determining the disparity between the pixels in the images within a light field due to parallax. A depth map indicates the distance of the surfaces of scene objects from a reference viewpoint. In a number of embodiments, the computational complexity of generating depth maps is reduced by generating an initial low resolution depth map and then increasing the resolution of the depth map in regions where additional depth information is desirable such as (but not limited to) regions involving depth transitions and/or regions containing pixels that are occluded in one or more images within the light field. The depth map may then be used determine the depth of each projected pixel and correct for the depth to make the image appear to be smooth using process 700 as discussed above.

Although a specific process for determining the depth of projected pixels on the focal plane or projected surface in accordance with embodiments of this invention with respect to FIG. 8, any of a variety of processes may be utilized in accordance with embodiments of the invention.

Although the present invention has been described in certain specific aspects, many additional modifications and variations would be apparent to those skilled in the art. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A projector array comprising:
a plurality of projection components wherein the plurality of projection components are configured in an array, each of the plurality of projection components receive lower resolution image data and project a lower resolution image onto a mutual projection surface based upon the received lower resolution image data and the lower resolution images projected by the plurality of projection components combine to form a higher resolution image;
a memory; and
a processor configured by an application stored in the memory to:
receive image data for a higher resolution image to be projected by the projector array from an external source,
apply inverse super resolution image processing algorithms to the received higher resolution image data to generate lower resolution image data for the lower resolution image to be projected by for each of the plurality of projection components wherein the lower resolution image projected by each of the plurality components has a lower resolution than the higher resolution image, and
provide the lower resolution image data to the plurality of projection components.

2. The projector array of claim 1 wherein the plurality of projection components comprises:
an array of display components; and
an array of lens stacks wherein each of the array of lens stacks is aligned with one of the array of display components

3. The projector array of claim 2 wherein each of the plurality of display components comprises an array of light emitting devices.

4. The projector array of claim 3 wherein the light emitting devices are one of Light Emitting Diodes (LEDs) and Organic Light Emitting Diodes (OLEDs).

5. The projector array of claim 2 wherein each of the array of lens stacks has a Modulated Transfer Function (MTF) that is at least equal to the MTF of the high resolution image.

6. The projector array of claim 2 wherein the array of display components is a monolithic component and the array of lens stacks is a monolithic component together forming a monolithic integrated module.

7. The projector array of claim 6 wherein the array of lens stacks are manufactured using a process selected from a group consisting of Wafer Level Optics (WLO), plastic injection molding, and precision glass molding.

8. The projector array of claim 1 wherein each of the plurality of projection components is configured to project images of a particular color.

9. The projector array of claim 1 wherein the application further configures the processor to apply photometric correction data to the low resolution image data provided to each of the plurality of projection components to correct for photometric errors in each of the plurality of projection components.

10. The projector array of claim 1 wherein the application further configures the processor to apply geometric correction data to the low resolution image data provided to each of the plurality of projection components to correct for geometric errors in each of the plurality of projection components.

11. The projector array of claim 1 wherein the application further configures the processor to apply translation data to the low resolution data provided to each of the plurality of projection components to configure corresponding pixel projections in the plurality of projection components to produce a desired higher resolution image at a given projection distance.

12. The projector array of claim 1 wherein the configuration of the processor to apply the inverse super resolution processing algorithms includes configuring the processor to:
determine parallax correction data for each of the plurality of projection components for a given projection distance that includes radical shifts at one of a level selected from a group consisting of a sub-pixel level, a pixel level, and a larger than pixel level based upon the projection distance and a position of a channel in a particular projection component in the array; and
apply the parallax correction data to the lower resolution image data of each of the projection components in the projector array.

13. The projector array of claim 12 wherein the configuration of the processor to apply the inverse super resolution processing algorithms includes configuring the processor to:
determine inverse super resolution correction data for the lower resolution image data for each of the plurality of projection components to cause an increased resolution in the physical superposition of the lower resolution images projected by each of the plurality of projection components over that resolution of the individually projected images where the inverse super resolution correction data includes sub-pixel level shifts of the lower resolution data that result from a deviation from a perfect parallax correction; and
apply the inverse super resolution correction data to the lower resolution image data of each of the plurality of projection components.

14. The projector array of claim 1 wherein the configuration of the processor to apply the inverse super resolution processing algorithms includes configuring the processor to:
shift pixel information in the higher resolution image data by a predetermined amount for each of the plurality of projection components; and
downsample the pixel information in higher resolution image data to a lower resolution pixel grid for the lower resolution image data of each of the plurality of projection components where the intensity values of the pixels in lower resolution image data for each of the plurality of projection components are different depending on the amount of the shift of the higher resolution pixel information for the particular projection components and the intensity differences in conjunction with sub-pixel offsets between the projected position of pixels of different projection components later overlap in the projection surface to form the higher resolution image.

15. The projector array of claim 1 wherein the application further configures the processor to apply focal data to the low resolution data to provide a desired resolution at a projection surface for each of the plurality of projection components.

16. The projection array of claim 15 wherein the application further configures the processor to generate the focal data by performing a focal calibration process.

17. A method for providing a high resolution image using a projector array comprising:
receiving higher image data for a higher resolution image to be projected by a plurality of projection components in an image processing system wherein the plurality of projection components are configured in an array;
applying inverse super resolution image processing algorithms to the higher resolution image data to generate lower resolution image data of lower resolution images for each of the plurality of projection components using the image processing system;
providing the lower resolution image data from the image processing system to the plurality of projection components;
generating a lower resolution image using a display component in each of the plurality of projection components;
projecting each lower resolution image generated by a display component through a lens stack associated with the display component unto a mutual projection surface whether a higher resolution image is provided by a combination of lower resolution images.

18. The method of claim 17 wherein each of the plurality of projection components is configured to project images of a particular color through the lens stack.

19. The method of claim 17 further comprising applying photometric correction data to the low resolution image data provided to each of the plurality of projection components to correct for photometric errors in each of the plurality of projection components using the image processing system.

20. The method of claim 17 further comprising applying geometric correction data to the low resolution image data provided to each of the plurality of projection components to correct for geometric errors in each of the plurality of projection components using the image processing system to produce a desired higher resolution image at a given projection distance.

21. The method of claim 17 further comprising applying translation data to the low resolution data provided to each of the plurality of projection components to configure corresponding pixel projections in the plurality of projection components using the image processing system.

22. The method of claim 17 wherein the applying the inverse super resolution processing algorithms comprises:
determining parallax correction data for each of the plurality of projection components for a given projection distance that includes radical shifts at one of a level selected from a group consisting of a sub-pixel level, a pixel level, and a larger than pixel level based upon the projection distance and a position of a channel in a particular projection component in the array; and
applying the parallax correction data to the lower resolution image data of each of the projection components in the projector array.

23. The method of claim 22 wherein the applying of the inverse super resolution algorithms further comprises:
determining inverse super resolution correction data for the lower resolution image data for each of the plurality of projection components to cause an increased resolution in the physical superposition of the lower resolution image projected by each of the plurality of projection components over the resolution of the individual projected images where the inverse super resolution correction data includes sub-pixel level shifts of the lower resolution data that result from a deviation from a perfect parallax correction;
applying the inverse super resolution correction data to the lower resolution image data of each of the plurality of projection components.

24. The method of claim 17 wherein applying the inverse super resolution processing comprises:
shifting pixel information in the higher resolution image data by a predetermined amount for each of the plurality of projection components; and
downsampling the pixel information in higher resolution image data to a lower resolution pixel grid for the lower resolution image data of each of the plurality of projection components where the intensity values of the pixels in lower resolution image data for each of the plurality of projection components are different depending on which amount of the shift the of the higher resolution pixel information for the particular projection components and the intensity differences in conjunction with sub-pixel offsets between the projected position of pixels of different projection components later overlap in the projection surface to form the higher resolution image.

25. The method of claim 17 further comprising applying focal data to the low resolution data to provide a desired resolution at a projection surface for each of the plurality of projection components using the image processing system.

26. The method of claim 25 further comprising generating the focal data by performing a focal calibration process using the image processing system and the plurality of projection components.
